(19) United States
(12) Patent Application Publication
(10) Pub. No.: US 2026/0151998 A1
(43) Pub. Date: Jun. 4, 2026

(54) LIQUID EJECTION SUBSTRATE, LIQUID EJECTION HEAD, AND METHOD FOR MANUFACTURING LIQUID EJECTION SUBSTRATE

(71) Applicant: CANON KABUSHIKI KAISHA, Tokyo (JP)

(72) Inventor: SEIICHIRO YAGINUMA, Kanagawa (JP)

(21) Appl. No.: 19/408,965

(22) Filed: Dec. 4, 2025

(30) Foreign Application Priority Data
Dec. 4, 2024 (JP) 2024-211094

(51) Int. Cl. B41J 2/14; B41J 2/16

(52) U.S. Cl. CPC B41J 2/1433; B41J 2/14016; B41J 2/14201; B41J 2/1606; B41J 2/1626; B41J 2/164; B41J 2002/14306

(57) ABSTRACT

A liquid ejection substrate configured to eject a liquid includes: a flow passage forming substrate having a first surface, a second surface, and a flow passage, the second surface facing in a direction opposite to a direction in which the first surface faces, the flow passage penetrating from the first surface to the second surface and being configured to allow the liquid to flow through the flow passage; a first functional layer covering the second surface and an inner peripheral surface of the flow passage; and a second functional layer covering the first functional layer formed on the second surface of the flow passage forming substrate.

### BACKGROUND

### Field of the Technology

The present disclosure relates to a liquid ejection substrate, a liquid ejection head, and a method for manufacturing a liquid ejection substrate.

### Description of the Related Art

Japanese Patent Laid-Open No. 2019-72882 discloses a liquid ejection head (a liquid ejection substrate) including a perforated substrate (a flow passage forming substrate) having through holes (flow passages). In Japanese Patent Laid-Open No. 2019-72882, this perforated substrate is such that a first surface, a second surface corresponding to a backside of the first surface, and inner wall surfaces (inner peripheral surfaces) of through holes penetrating from the first surface to the second surface are covered with a protective film (a functional layer). In this way, the liquid ejection head of Japanese Patent Laid-Open No. 2019-72882 can suppress the elution of a resin material, which is contained in the perforated substrate, into a liquid which flows through the through hole.

However, in the liquid ejection head of Japanese Patent Laid-Open No. 2019-72882, there is still room for further improving an adhesion between a flow passage forming substrate and a functional layer in order to obtain a sufficient protection performance in the functional layer.

### SUMMARY

An object of the present disclosure is to provide a liquid ejection substrate which can further improve an adhesion between a flow passage forming substrate and a functional layer.

A liquid ejection substrate configured to eject a liquid includes: a flow passage forming substrate having a first surface, a second surface, and a flow passage, the second surface facing in a direction opposite to a direction in which the first surface faces, the flow passage penetrating from the first surface to the second surface and being configured to allow the liquid to flow through the flow passage; a first functional layer covering the second surface and an inner peripheral surface of the flow passage; and a second functional layer covering the first functional layer formed on the second surface of the flow passage forming substrate.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic perspective view of a liquid ejection apparatus applicable to an embodiment;

FIG. 2 is a diagram for explaining a liquid ejection head of an embodiment;

FIG. 3A is a schematic sectional perspective view of a liquid ejection substrate;

FIG. 3B is a schematic sectional view of the liquid ejection substrate as viewed along an X-direction;

FIG. 3C is a schematic sectional view of the liquid ejection substrate as viewed along a Y-direction;

FIG. 3D is a schematic plan view of the liquid ejection substrate applicable to an embodiment;

FIG. 4 is a diagram showing Comparative Example of the liquid ejection substrate;

FIG. 5A is a diagram showing an example of a step of a method for manufacturing a liquid ejection substrate;

FIG. 5B is a diagram showing an example of a step of the method for manufacturing a liquid ejection substrate;

FIG. 5C is a diagram showing an example of a step of the method for manufacturing a liquid ejection substrate;

FIG. 5D is a diagram showing an example of a step of the method for manufacturing a liquid ejection substrate;

FIG. 5E is a diagram showing an example of a step of the method for manufacturing a liquid ejection substrate;

FIG. 5F is a diagram showing an example of a step of the method for manufacturing a liquid ejection substrate;

FIG. 5G is a diagram showing an example of a step of the method for manufacturing a liquid ejection substrate;

FIG. 5H is a diagram showing an example of a liquid ejection substrate;

FIG. 6A is a schematic sectional view of a liquid ejection substrate in a modification;

FIG. 6B is a schematic plan view of the liquid ejection substrate in a modification;

FIG. 6C is a schematic sectional view of a liquid ejection substrate in a modification;

FIG. 6D is a schematic plan view of the liquid ejection substrate in a modification;

FIG. 6E is a schematic sectional view of a liquid ejection substrate in a modification;

FIG. 6F is a schematic plan view of the liquid ejection substrate in a modification;

FIG. 6G is a schematic sectional view of a liquid ejection substrate in a modification;

FIG. 6H is a schematic plan view of the liquid ejection substrate in a modification;

FIG. 6I is a schematic sectional view of a liquid ejection substrate in a modification;

FIG. 6J is a schematic plan view of the liquid ejection substrate in a modification;

FIG. 6K is a schematic sectional view of a liquid ejection substrate in a modification;

FIG. 6L is a schematic plan view of the liquid ejection substrate in a modification;

FIG. 7A is a schematic sectional view of a liquid ejection substrate in an embodiment;

FIG. 7B is a schematic sectional view of a liquid ejection substrate in a modification;

FIG. 7C is a schematic sectional view of a liquid ejection substrate in a modification; and

FIG. 7D is a schematic sectional view of a liquid ejection substrate in a modification.

### DESCRIPTION OF THE EMBODIMENTS

### First Embodiment

### Liquid Ejection Apparatus 100

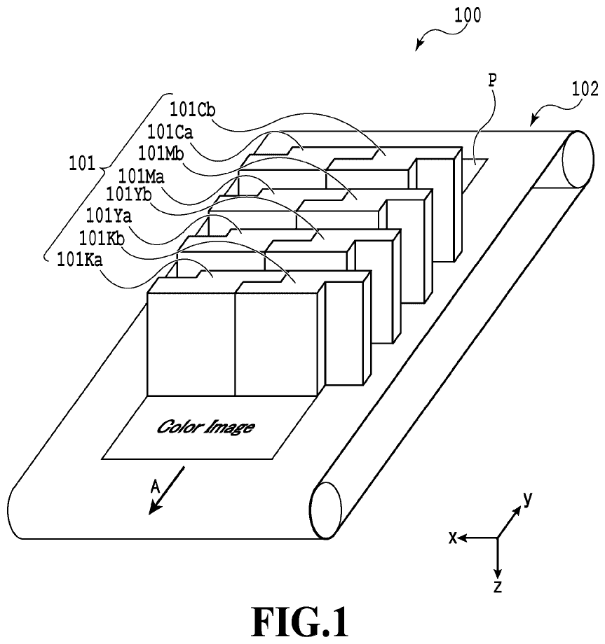

FIG. 1 is a schematic perspective view of a liquid ejection apparatus 100 applicable to the present embodiment.

As shown in FIG. 1, the liquid ejection apparatus 100 includes: liquid ejection heads 101 of one pass-type configured to move a printing medium P at once and print an image on the printing medium P; and a conveying device 102 configured to convey the printing medium P.

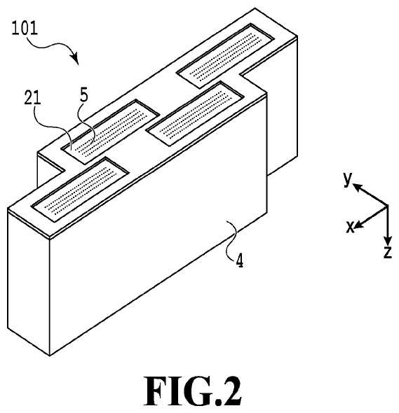

In the liquid ejection heads 101, a plurality of ejection ports 5 (see FIG. 2 and the like) for ejecting liquids (for example, inks) are arrayed across a side corresponding to the entire width (the length in an X-direction) of the printing medium P.

In the present embodiment, the liquid ejection heads 101 correspond to four colors of cyan (C), magenta (M), yellow (Y), and black (K). Specifically, the liquid ejection heads 101 include a first liquid ejection head 101Ca and a second liquid ejection head 101Cb which correspond to an ink of cyan (C). The liquid ejection heads 101 include a third liquid ejection head 101Ma and a fourth liquid ejection head 101Mb which correspond to an ink of magenta (M). The liquid ejection heads 101 include a fifth liquid ejection head 101Ya and a sixth liquid ejection head 101Yb which correspond to an ink of yellow (Y). The liquid ejection head 101 includes a seventh liquid ejection head 101Ka and an eighth liquid ejection head 101Kb which correspond to an ink of black (K).

The printing medium P is conveyed in a direction of an arrow A by the conveying device 102. Printing is performed on the printing medium P by the liquid ejection heads 101.

Note that the liquid ejection apparatus 100 shown in FIG. 1 is merely an example. The liquid ejection apparatus 100 may be configured such that liquid ejection heads 101 of any form can be mounted on the liquid ejection apparatus 100. For example, the liquid ejection heads 101 may be configured to be capable of ejecting only an ink of one type, or may be configured to be capable of ejecting inks of types greater than the above-mentioned four types.

### Liquid Ejection Head 101

FIG. 2 is a perspective view showing the liquid ejection head 101 of any one color among the liquid ejection heads 101 shown in FIG. 1. Note that in FIG. 2, the liquid ejection head 101 is shown in an orientation obtained by flipping the liquid ejection head 101 shown in FIG. 1 upside down.

As shown in FIG. 2, the liquid ejection head 101 includes a head main body 4. Inside the head main body 4, an electric board (not shown) for supplying electric power and signals necessary for ejecting the liquid is provided. The head main body 4 is provided with a plurality of liquid ejection substrates 21 each capable of ejecting the liquid. Note that in the present embodiment, four liquid ejection substrates 21 are provided.

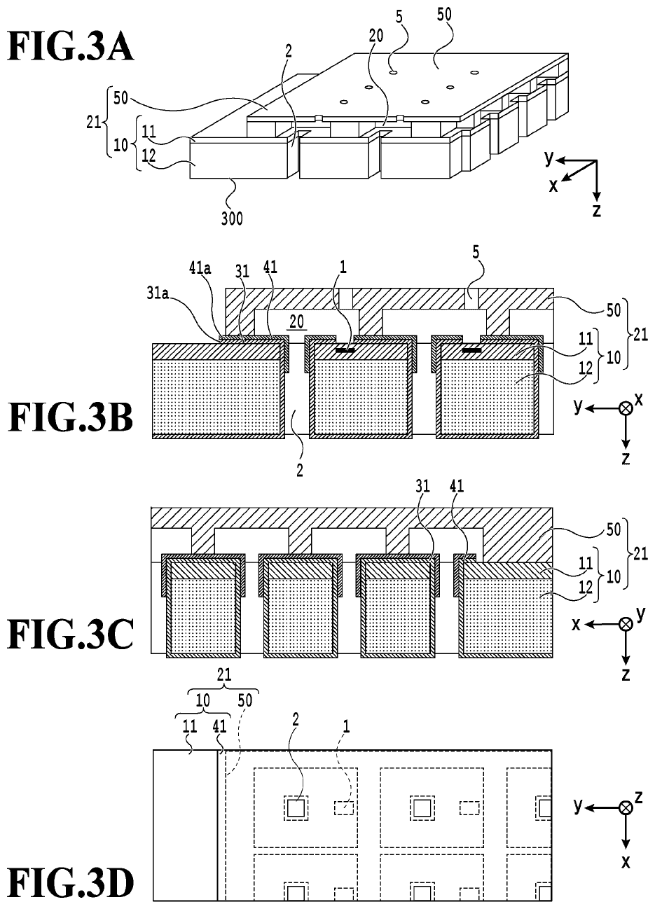

Each of the plurality of liquid ejection substrates 21 includes terminals (not shown). These terminals and the above-mentioned electric board are connected via wirings (not shown). This makes it possible to supply electric power and signals necessary for ejecting the liquid from this electric board, to energy generation elements 1 (see FIG. 3B) configured to generate an energy for ejecting the liquid.

In each liquid ejection substrate 21, a plurality of ejection ports 5 are formed. The liquid to be ejected from the liquid ejection head 101 is supplied from a liquid tank (not shown) for reserving the liquid to the liquid ejection substrates 21 via a common supply port (not shown) of the head main body 4. In an ejection port surface (a surface facing upward in FIG. 2) of the liquid ejection substrate 21, the plurality of ejection ports 5 are arrayed along the X-direction, so that one ejection port array is formed.

In addition, in the ejection port surface, a plurality of ejection port arrays are formed along a Y-direction intersecting (in the present embodiment, being orthogonal to) the X-direction. Then, the ejection ports 5 that are formed in an end portion in the X-direction are disposed in such a manner as to be placed over the ejection ports 5 of another liquid ejection substrate 21 along the Y-direction. Disposing each liquid ejection substrate 21 in this way makes it possible to achieve printing with long ejection port arrays.

FIG. 3A is a schematic sectional perspective view of the liquid ejection substrate 21.

As shown in FIG. 3A, the liquid ejection substrate 21 includes: a flow passage forming substrate 10 in which flow passages 2 are formed; and an ejection port forming substrate 50 in which the ejection ports 5 are formed.

The flow passage forming substrate 10 is configured by forming a device layer 11 which includes a silicon layer formed of silicon, a metal film, and an insulating film, on an upper surface of a silicon substrate 12 containing silicon. In the ejection port forming substrate 50, pressure chambers 20 which receive pressure at the time of ejecting the liquid are also formed in addition to the ejection port 5.

FIG. 3B is a schematic sectional view of the liquid ejection substrate 21 as viewed along the X-direction.

As shown in FIG. 3B, between the ejection port forming substrate 50 and the flow passage forming substrate 10, a first functional layer 31 which has a function of protecting the flow passage forming substrate 10, and a second functional layer 41 which has a function of protecting the first functional layer 31 are formed.

The flow passages 2 are formed in such a manner as to penetrate the main body of the flow passage forming substrate 10 along the Z-direction in the state where a lower surface of the ejection port forming substrate 50 is fixed to an upper surface of the device layer 11. The flow passages 2 are connected to the pressure chambers 20 in the state where the lower surface of the ejection port forming substrate 50 is fixed to an upper surface of the second functional layer 41. In the ejection port forming substrate 50, the pressure chambers 20 are connected to the ejection ports 5.

In the device layer 11, energy generation elements 1 are provided. The energy generation elements 1 are provided at positions corresponding to the ejection ports 5. Note that in the present embodiment, heaters are used as the energy generation elements 1.

The heating of the heaters in the state where the inside of the pressure chamber 20 is filled with the liquid causes film boiling in the liquid inside the pressure chamber 20. By using bubble generating energy generated by this film boiling, the liquid is ejected from the ejection ports 5. In this way, in the liquid ejection substrate 21 of the present embodiment, in the case where the liquid is to be ejected, the liquid is supplied through the flow passages 2, the pressure chambers 20, and the ejection ports 5 in this order.

The first functional layer 31 is configured in such a manner as to have a resistance (for example, ink resistance) against the liquid (for example, an ink) and a coverage for covering the flow passage forming substrate 10. For example, it is preferable that the first functional layer 31 be formed in such a manner as to be a metal oxide film containing at least one of Ti, Zr, Hf, V, Nb, and Ta. This configuration allows the first functional layer 31 to achieve both liquid contact property and coverage.

Then, the first functional layer 31 is formed in such a manner as to continuously cover the lower surface of the flow passage forming substrate 10, the inner peripheral surface of the flow passage 2, and the upper surface of the flow passage forming substrate 10. This configuration makes it possible to prevent the component of the flow passage forming substrate 10 from melting into the liquid and the liquid from eroding the flow passage forming substrate 10. Moreover, an adhesion area to the flow passage forming substrate 10 can also be sufficiently ensured.

However, the first functional layer 31 does not cover the entire upper surface of the flow passage forming substrate 10. In the upper surface of the flow passage forming substrate 10, the first functional layer 31 is not formed at positions corresponding to the energy generation elements 1. This is because if the first functional layer 31 is present at these positions, the transfer of the energy generated by the energy generation element 1 to the liquid is inhibited.

In the present embodiment, an end portion 31a of the first functional layer 31 is formed outside the ejection port forming substrate 50 in the state where the ejection port forming substrate 50 is fixed to the flow passage forming substrate 10. Forming the end portion 31a of the first functional layer 31 at a position relatively away from the ejection ports 5 makes it unlikely for the liquid to permeate into the interface between the device layer 11 and the first functional layer 31, thus improving the adhesion of the first functional layer 31 to the device layer 11.

As mentioned above, the first functional layer 31 is formed such that the adhesion of the first functional layer 31 to the flow passage forming substrate 10 can be sufficiently ensured. However, there is also a case where the first functional layer 31 is peeled off the flow passage forming substrate 10 for some reason. In order to suppress such a situation, in the present embodiment, the second functional layer 41 for protecting the first functional layer 31 is formed.

In the present embodiment, the second functional layer 41 is formed in such a manner as to cover the first functional layer 31 which covers the upper surface of the flow passage forming substrate 10 and the first functional layer 31 which covers the inner peripheral surface of the flow passage 2. However, on the inner side of the flow passage 2, the second functional layer 41 is formed in such a manner as to cover the first functional layer 31 which is formed near the outlet of the flow passage 2, but is not formed in such a manner as to cover the first functional layer 31 which is formed near the inlet of the flow passage 2. In this way, although the first functional layer 31 is formed on the entirety of the inner side of the flow passage 2, the second functional layer 41 is not formed on the entirety of the inner side of the flow passage 2. That is, although the first functional layer 31 is formed on the entirety of the inner side of the flow passage 2, the second functional layer 41 is formed on part of the inner side of the flow passage 2.

Then, the position of an end portion 41a of the second functional layer 41 in the Y-direction is aligned with the position of the end portion 31a of the first functional layer 31 in the Y-direction. According to this configuration, on the upper surface of the flow passage forming substrate 10, the end portion 41a of the second functional layer 41 and the end portion 31a of the first functional layer 31 are formed at positions which are away from the ejection ports 5, where the liquid is unlikely to attach. Hence, since the permeation of the liquid into the interface between the second functional layer 41 and the first functional layer 31 is suppressed, the adhesion of the second functional layer 41 to the first functional layer 31 is ensured. In this way, the formation pattern of the first functional layer 31 and the formation pattern of the second functional layer 41 are different from each other.

In addition, the second functional layer 41 has resistance to the liquid and adhesion to the first functional layer 31.

In the present embodiment, the second functional layer 41 is a film formed of a Si compound selected from the group consisting of SiC, SiOC, SiCN, SiOCN, SiO, SiN, and SiON. However, as long as the material for forming the second functional layer 41 has resistance to the liquid and adhesion to the first functional layer 31, the material for forming the second functional layer 41 is not limited to the above-mentioned materials.

In order to enhance the adhesion of the second functional layer 41 to the first functional layer 31, it is effective to make the stress of the film compressive and to enhance the stress.

Here, the stress of a film means the internal stress of the film. In general, the internal stress of a film is evaluated by measuring a warpage of a structure before the film is formed on the structure, and a warpage of the structure after the film is formed on the structure, and is represented by a force per unit area. In the case of measuring the stress of a film formed on a structure, the stress of the film can be detected by cutting out a portion where the film is formed from the structure, and measuring a deformation amount of the structure before and after the film is removed. Alternatively, in the case where the structure is a crystal, the stress of the film can be detected also by evaluating distortion which the stress applies to the grid of the crystal by X-ray diffraction or the like.

In the present embodiment, in the case where the stress of the first functional layer 31 is tensile, if the stress of the second functional layer 41 is compressive, the adhesion of the second functional layer 41 to the first functional layer 31 can be improved.

On the other hand, in the case where the stress of the first functional layer 31 is compressive, if the stress of the second functional layer 41 is compressive and has a larger stress value than that of the first functional layer 31, the adhesion of the second functional layer 41 to the first functional layer 31 can be improved.

However, in the case where the stress value of the second functional layer 41 is too large, if the flow passage forming substrate 10 is largely bent for some reason, a problem can occur in the adhesion of the second functional layer 41 to the first functional layer 31 in some cases.

In view of this, in the present embodiment, the second functional layer 41 is configured such that the stress value falls within a predetermined range. For example, it is preferable that the stress value of the second functional layer 41 be 100 MPa or more and 600 MPa or less. It is more preferable that the stress value of the second functional layer 41 be 200 MPa or more and 400 MPa or less. According to this configuration, even in the case where the flow passage forming substrate 10 is largely bent, the adhesion of the second functional layer 41 to the first functional layer 31 can be ensured.

In addition, it is preferable that the Young's modulus of the material of the second functional layer 41 be larger than the Young's modulus of the material of the first functional layer 31. For example, it is preferable that the Young's modulus of the bulk of the material used for the second functional layer 41 be 300 GPa or more. It is more preferable that the Young's modulus of the bulk of the material used for the second functional layer 41 be 400 GPa or more. By increasing the Young's modulus of the material of the second functional layer 41 in this way, the deformation of the second functional layer 41 is suppressed, so that the adhesion of the second functional layer 41 to the first functional layer 31 can be ensured.

In addition, it is preferable that the thickness (the length in the Z-direction) of the second functional layer 41 be larger than the thickness of the first functional layer 31. This is because it is considered that the larger the force necessary for bending the second functional layer 41 is, the more difficult it is to physically peel off the first functional layer 31 from the flow passage forming substrate 10.

If the second functional layer 41 is cut out into a thin plate shape and is deformed at a predetermined curvature, the stress value of the second functional layer 41 is proportional to the thickness of the second functional layer 41. That is, the larger the thickness of the second functional layer 41 is, the larger force is necessary for deforming the second functional layer 41.

For example, it is preferable that the thickness of the second functional layer 41 be 1.5 times or more the thickness of the first functional layer 31. It is more preferable that the thickness of the second functional layer 41 be 2 times or more the thickness of the first functional layer 31. By making the thickness of the second functional layer 41 larger than the thickness of the first functional layer 31, the rigidity of the second functional layer 41 is improved, so that the adhesion of the first functional layer 31 to the flow passage forming substrate 10 can also be improved.

In addition, although described in detail later, it is preferable that the flow passage forming substrate 10 and the first functional layer 31 contain the same material. According to this configuration, the interface between the flow passage forming substrate 10 and the first functional layer 31 can be more firmly adhered.

Then, it is preferable that the first functional layer 31 and the second functional layer 41 contain the same material. According to this configuration, the interface between the first functional layer 31 and the second functional layer 41 can be more firmly fixed.

Moreover, it is preferable that the second functional layer 41 and the ejection port forming substrate 50 contain the same material. According to this configuration, the interface between the second functional layer 41 and the ejection port forming substrate 50 can be more firmly fixed.

In the case where the quality of the second functional layer 41 and the degree of freedom in selecting materials can be improved in this way, the adhesion of the ejection port forming substrate 50 to the second functional layer 41 can also be improved.

The configuration in which the ejection port forming substrate 50 is fixed to the second functional layer 41 is particularly preferable in the case where the shrink of the liquid ejection substrate 21, the densification of the energy generation elements 1, the use of a new type of ink, and the circulation of the ink are performed.

FIG. 3C is a schematic sectional view of the liquid ejection substrate 21 as viewed along the Y-direction.

As shown in FIG. 3C, in the case where the liquid ejection substrate 21 is viewed along the Y-direction as well, the second functional layer 41 covers the first functional layer 31. With the configuration in which the second functional layer 41 covers only part of the first functional layer 31 in this way, it is possible to protect the first functional layer 31. That is, the second functional layer 41 may cover only a front face of the first functional layer 31 (a surface as viewed along the X-direction), or may cover only a side surface of the first functional layer 31 (a surface as viewed along the Y-direction).

Note that although in the example of FIG. 3C, a section of the side surface of the flow passage forming substrate 10 is shown, the first functional layer 31 and the second functional layer 41 may be formed in such a manner as to cover the side surface of the flow passage forming substrate 10. With this configuration as well, the flow passage forming substrate 10 is sufficiently protected by the first functional layer 31, and the first functional layer 31 is sufficiently protected by the second functional layer 41.

FIG. 3D is a schematic plan view of the liquid ejection substrate 21 applicable to the present embodiment. Note that in FIG. 3D, the ejection port forming substrate 50 is indicated by a dashed line.

As shown in FIG. 3D, in the state where the liquid ejection substrate 21 is viewed in a plan view as well, the first functional layer 31 (see FIG. 3B and the like) is covered with the second functional layer 41.

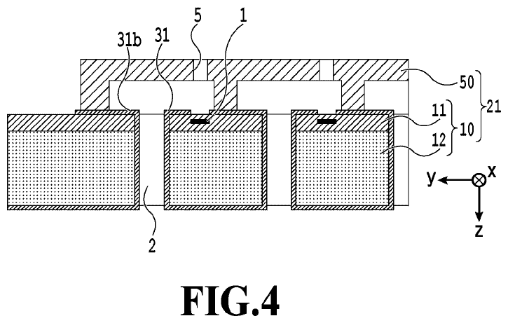

FIG. 4 is a diagram showing Comparative Example of the liquid ejection substrate 21. FIG. 4 shows the liquid ejection substrate 21 that does not include the second functional layer 41 in order to explain the effect of the second functional layer 41 (see FIG. 3B and the like).

As shown in FIG. 4, in the present Comparative Example, since the second functional layer 41 is not formed, the first functional layer 31 is not protected.

An example of the method for forming the first functional layer 31 includes a publicly-known atomic layer deposition method (an ALD method). The ALD method is excellent in coverage, but tends to be not excellent in adhesion. This is because in the ALD method, a film is formed by physical adsorption.

In view of this, in the technology of the present disclosure, the second functional layer 41 (see FIG. 3B and the like) is formed on the first functional layer 31 to protect the first functional layer 31. Note that the position at which to form the first functional layer 31 is not particularly limited; however, in the present embodiment, the second functional layer 41 is formed on a corner portion 31b of the first functional layer 31. This is because there is also a case where the corner portion 31b of the first functional layer 31 easily peels off from the flow passage forming substrate 10 depending on the configuration of the liquid ejection substrate 21.

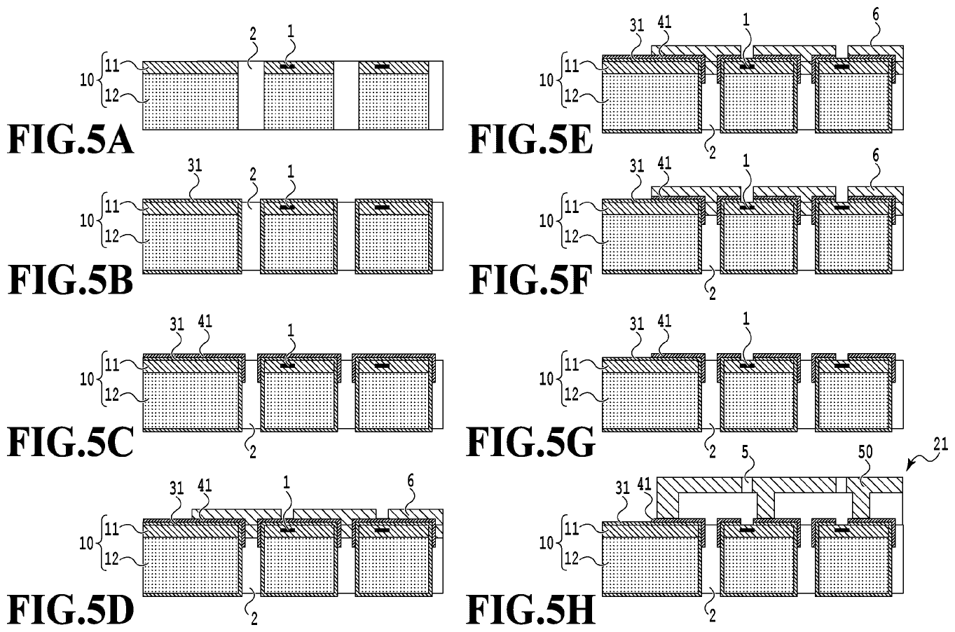

FIGS. 5A to 5F are diagrams showing an example of a method for manufacturing the liquid ejection substrate 21 applicable to the present embodiment.

As shown in FIG. 5A, the flow passage forming substrate 10 in which a lower surface of the device layer 11 is fixed to an upper surface of the silicon substrate 12 is prepared. However, at this stage, the energy generation elements 1 are provided and the flow passages 2 are formed at this stage, but the first functional layer 31 and the second functional layer 41 are not formed.

As shown in FIG. 5B, the first functional layer 31 is formed on the flow passage forming substrate 10 obtained in FIG. 5A. At this stage, the first functional layer 31 is formed continuously on the upper surface of the device layer 11, the inner peripheral surface of the flow passage 2, and the lower surface of the silicon substrate 12. Note that the first functional layer 31 is formed in such a manner as not to seal the flow passage 2.

In the present embodiment, the first functional layer 31 is formed by the ALD method. The ALD method can maintain the protectiveness to the flow passages 2 as compared with the other methods. Note that as long as the protectiveness to the flow passages 2 can be maintained, the method for forming the first functional layer 31 is not limited to the ALD method.

As shown in FIG. 5C, the second functional layer 41 is formed on the flow passage forming substrate 10 obtained in FIG. 5B. At this stage, the second functional layer 41 is formed in such a manner as to cover the entirety of the first functional layer 31 which covers the upper surface of the device layer 11 and part of the first functional layer 31 which covers the inner peripheral surface of the flow passage 2.

In the present embodiment, the second functional layer 41 is formed by a plasma chemical vapor deposition method (plasma CVD method). Another example of the method which is capable of forming the second functional layer 41 includes a sputtering method and the like. By forming the second functional layer 41 by using the plasma CVD method or the sputtering method, the adhesion of the second functional layer 41 and the ejection port forming substrate 50 can be improved as compared with the other methods.

Particularly, in the case where a mask pattern is formed at a high density, it is preferable that the plasma CVD method or the sputtering method be used. This is because by using the plasma CVD method or the sputtering method, it becomes easier to ensure an area where the second functional layer 41 and the ejection port forming substrate 50 adhere than the other methods. Note that as long as the adhesion to the first functional layer 31 can be ensured, the method for forming the second functional layer 41 is not limited to the plasma CVD method or the sputtering method.

As shown in FIG. 5D, by using a publicly-known method, a resist 6 is formed on the flow passage forming substrate 10 obtained in FIG. 5C, and the resist 6 is subjected to exposure and development to form a predetermined resist mask. An example of the method for forming the resist 6 includes a method including laminating a resist 6 formed into a dry film on the flow passage forming substrate 10. Note that the method for forming the resist 6 is not limited to this.

At this stage of the present embodiment, a resist mask for removing the second functional layer 41 and the first functional layer 31 which have been formed at positions corresponding to the energy generation elements 1 is formed.

In addition, it is preferable that one resist mask common to the second functional layer 41 and the first functional layer 31 be formed. According to this method, the number of steps for forming a resist mask can be reduced as compared with the case of forming resist masks individually for the second functional layer 41 and the first functional layer 31, respectively.

As shown in FIG. 5E, etching is performed on the flow passage forming substrate 10 obtained in FIG. 5D to remove the second functional layer 41 formed at positions corresponding to the energy generation elements 1.

In the etching of the present embodiment, the first functional layer 31 is used as a stop layer. By using the first functional layer 31 as a stop layer, the degree of freedom in processes can be improved while reducing a damage to the device layer 11. An example of the method for removing the second functional layer 41 includes dry etching. Note that as long as the method is suitable for the material of the second functional layer 41, the method for removing the second functional layer 41 is not limited to dry etching.

As shown in FIG. 5F, etching is performed on the flow passage forming substrate 10 obtained in FIG. 5E to remove the first functional layer 31 formed at positions corresponding to the energy generation elements 1. An example of the method for removing the first functional layer 31 includes wet etching. With wet etching, a damage to the device layer 11 can be reduced, and the control of the work can be facilitated, as compared with the other methods. Note that as long as the method is suitable for the material of the first functional layer 31, the method for removing the first functional layer 31 is not limited to wet etching.

As shown in FIG. 5G, by using a publicly-known approach, the resist 6 is peeled off from the flow passage forming substrate 10 obtained in FIG. 5F.

As shown in FIG. 5H, by using a publicly-known approach, an ejection port forming substrate 50 is formed on the flow passage forming substrate 10 obtained in FIG. 5G.

The manufacturing method applicable to the present embodiment is as described above.

### Example

Hereinafter, Example of the method for manufacturing the liquid ejection substrate 21 shown in FIG. 5H will be described.

First, a silicon substrate 12 was prepared, and a device layer 11 including energy generation elements 1 was formed on an upper surface of the silicon substrate 12.

Next, flow passages 2 were formed in a flow passage forming substrate 10 formed of the silicon substrate 12 and the device layer 11.

Next, a TiO film was formed as a first functional layer 31 by using the ALD method. The thickness of this TiO film was 50 nm. The tensile stress of this TiO film was 300 MPa.

Next, a SiC film was formed as a second functional layer 41 by using the plasma CVD method. The thickness of this SiC film was 100 nm. The compressive stress of this SiC film was 300 MPa. According to literature values, the Young's modulus of TiO2 used as the material was 290 GPa, and the Young's modulus of SiC used as the material was 440 GPa. In this way, the Young's modulus of the second functional layer 41 was larger than the Young's modulus of the first functional layer 31.

Next, a resist 6 was formed on the flow passage forming substrate 10. In the resist 6, one resist mask to be used in common for the etching on the SiC film and the etching on the TiO film was formed.

Next, patterning was performed on the SiC film. In the etching in this patterning, dry etching was performed. In this dry etching, the TiO film was used as a stop layer.

Next, patterning was performed on the TiO film. In the etching in this patterning, wet etching was performed.

Next, the resist 6 was removed.

Next, an ejection port forming substrate 50 was formed.

The present example is as described above.

### Comparative Example

Hereinafter, Comparative Example of the method for manufacturing the liquid ejection substrate 21 shown in FIG. 4 will be described.

First, a silicon substrate 12 was prepared, and a device layer 11 including energy generation elements 1 was formed on an upper surface of the silicon substrate 12.

Next, flow passages 2 were formed in a flow passage forming substrate 10 formed of the silicon substrate 12 and the device layer 11.

Next, a TiO film was formed as the first functional layer 31 in the same manner as in Example.

Next, a resist 6 was formed on the flow passage forming substrate 10. In the resist 6, a resist mask having the same pattern as in Example was formed.

Next, patterning was performed on the TiO film. In the etching in this patterning, wet etching was performed.

Next, the resist 6 was removed.

Next, an ejection port forming substrate 50 was formed.

The liquid ejection substrate obtained by the manufacturing method of Example and the liquid ejection substrate obtained by the manufacturing method of Comparative Example were immersed in an ink, and were evaluated. The result of the evaluation indicated that the end portions of the first functional layer 31 of the liquid ejection substrate in Comparative Example were more likely to come off than the end portions of the first functional layer 31 of the liquid ejection substrate of Example. Hence, it is indicated that the adhesion of the first functional layer 31 to the flow passage forming substrate 10 in Example was improved as compared with the adhesion of the first functional layer 31 to the flow passage forming substrate 10 in Comparative Example.

As described above, in the present embodiment, since the second functional layer 41 is formed, the thickness of the functional layer which protects the flow passage forming substrate 10 becomes thick as compared with the case where the second functional layer 41 is not formed. That is, in the present embodiment, the rigidity of the functional layer which protects the flow passage forming substrate 10 is increased as compared with the case where the second functional layer 41 is not formed. Hence, a possibility that the first functional layer 31 is peeled off can be reduced as compared with the case where the second functional layer 41 is not formed.

Therefore, according to the liquid ejection substrate of the present embodiment, the adhesion between a flow passage forming substrate and a functional layer can be improved.

### First Modification in First Embodiment

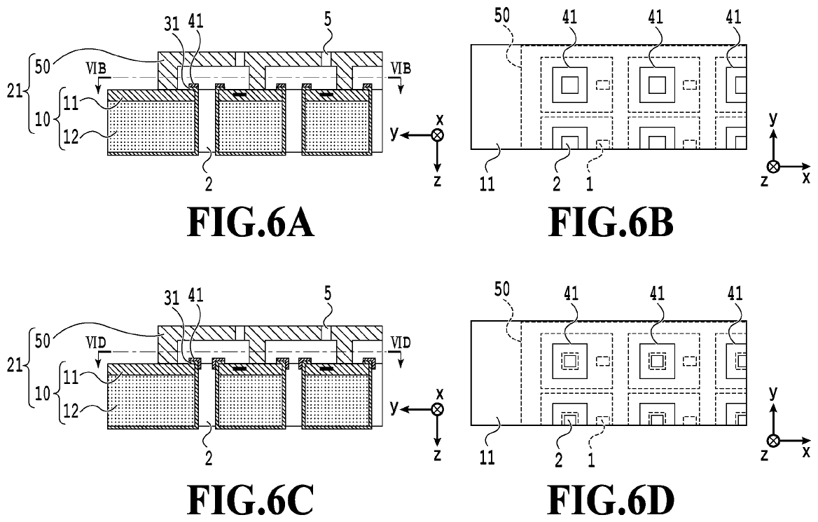

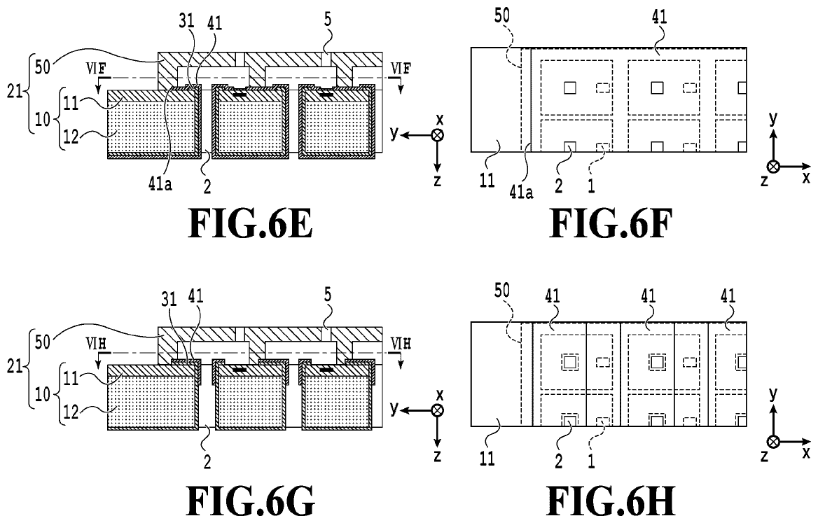

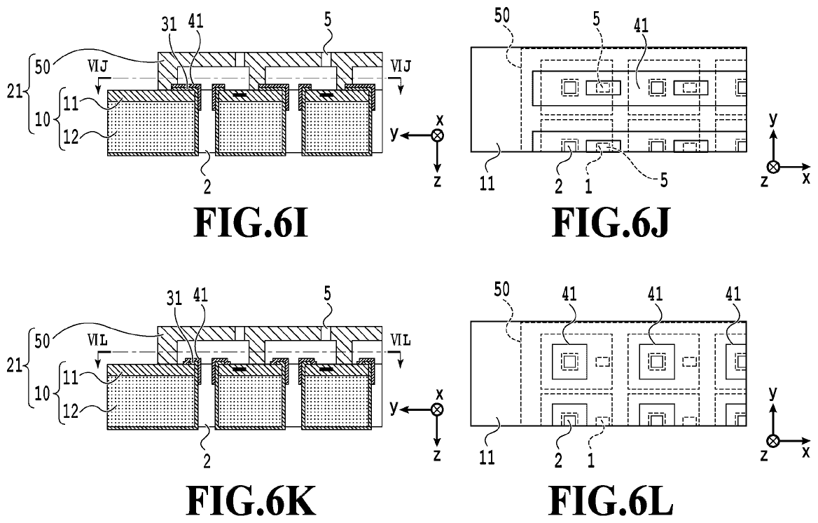

FIG. 6A is a schematic sectional view of a liquid ejection substrate 21 in a first modification.

FIG. 6B is a schematic plan view of the liquid ejection substrate 21 in the first modification. In FIG. 6B, the ejection port forming substrate 50 is indicated by a dashed line for the sake of convenience of the description. In plan views given below as well, the ejection port forming substrate 50 is indicated by a dashed line in the same manner as in FIG. 6B.

As shown in FIG. 6A and FIG. 6B, the first functional layer 31 and the second functional layer 41 may be formed only on the inner side of the ejection port forming substrate 50 on the upper surface of the device layer 11. On the upper surface of the first functional layer 31 in the present modification, only the vicinity of an outlet of the flow passage 2 is covered with the second functional layer 41.

For example, in the state (see FIG. 6A) where the section of the liquid ejection substrate 21 is viewed along the X-direction, the length, in the Y-direction, of the adhesion portion between the first functional layer 31 and the second functional layer 41 is 0.1μm or more. It is preferable that the length, in the Y-direction, of the adhesion portion between the first functional layer 31 and the second functional layer 41 be 1.0μm or more. It is further preferable that the length, in the Y-direction, of the adhesion portion between the first functional layer 31 and the second functional layer 41 be 5.0μm or more. This is because the longer the length, in the Y-direction, of the adhesion portion between the first functional layer 31 and the second functional layer 41 is, the more the adhesion between the first functional layer 31 and the second functional layer 41 is improved.

With this configuration as well, the adhesion between a flow passage forming substrate and a functional layer can be improved.

### Second Modification in First Embodiment

FIG. 6C is a schematic sectional view of a liquid ejection substrate 21 in a second modification.

FIG. 6D is a schematic plan view of the liquid ejection substrate 21 in the second modification.

As shown in FIG. 6C and FIG. 6D, the second functional layer 41 may have a configuration to cover the corner portion of the first functional layer 31 from an inner peripheral surface to an upper surface of the flow passage 2 in the vicinity of an outlet of the flow passage 2.

According to this configuration, since the interface between the first functional layer 31 and the device layer 11 is covered with the second functional layer 41, the permeation of the liquid into the interface between the first functional layer 31 and the device layer 11 can be suppressed. Note that in this configuration, the surface, which faces in the X-direction, of the liquid ejection substrate 21 may be covered with the second functional layer 41. In the following modifications as well, the surface, which faces in the X-direction, of the liquid ejection substrate 2 may be covered with the second functional layer 41.

With this configuration as well, the adhesion between a flow passage forming substrate and a functional layer can be improved.

### Third Modification in First Embodiment

FIG. 6E is a schematic sectional view of a liquid ejection substrate 21 in a third modification.

FIG. 6F is a schematic plan view of the liquid ejection substrate 21 in the third modification.

As shown in FIG. 6E and FIG. 6F, in the present modification, the second functional layer 41 covers the entirety of the first functional layer 31 on the inner side of the flow passage 2. Then, the second functional layer 41 covers the upper surface of the flow passage forming substrate 10 in a wider range than the first functional layer 31.

For example, in the case where the first functional layer 31 is formed of a resin, the adhesion of the ejection port forming substrate 50 to the first functional layer 31 becomes problematic. Specifically, in the case where the first functional layer 31 is formed of epoxy, silicone, benzocyclobutene, polyimide, or the like, the adhesion of the ejection port forming substrate 50 to the first functional layer 31 becomes problematic.

In addition, in the case where a layer which is likely to be dissolved into an ink is present in the interface between the flow passage forming substrate 10 and the first functional layer 31, and a new type of ink has permeated into this layer, the adhesion of the first functional layer 31 to the flow passage forming substrate 10 becomes problematic.

For example, in the case where an ink contains a new type of surfactant, there is a possibility that the ink permeates into the interface between the flow passage forming substrate 10 and the first functional layer 31. Besides, in the case where an ink for directly etching a pattern on a metal or the like is used, there is a possibility that the ink permeates into the interface between the flow passage forming substrate 10 and the first functional layer 31. Besides these, in the case where an ink having an acidic property or an alkaline property and an ink for directly printing a circuit are used, the adhesion of the first functional layer 31 to the flow passage forming substrate 10 becomes problematic.

In addition, in the case where an ink which is likely to permeate into the interface between the ejection port forming substrate 50 and the first functional layer 31 and an ink which is likely to swell are used, the adhesion of the first functional layer 31 to the ejection port forming substrate 50 becomes problematic. For example, in the case where an ink contains a new type of surfactant or organic solvent, there is a possibility that the ink permeates into the interface between the ejection port forming substrate 50 and the first functional layer 31. Besides this, in the case where an ink is heated or in the case where an ink is circulated, there is a possibility that the ink permeates into the interface between the ejection port forming substrate 50 and the first functional layer 31, so that the ejection port forming substrate 50 or the first functional layer 31 is dissolved.

However, according to the configuration of the present modification, the interface between the ejection port forming substrate 50 and the first functional layer 31 is covered with the second functional layer 41. This makes it possible to suppress the permeation of the liquid into the interface between the ejection port forming substrate 50 and the first functional layer 31.

Hence, as compared with a configuration in which the interface between the ejection port forming substrate 50 and the first functional layer 31 is not covered, the configuration of the present modification can improve the adhesion of the first functional layer 31 to the flow passage forming substrate 10.

Moreover, in the present modification, the first functional layer 31 which is formed continuously on the lower surface of the silicon substrate 12, the inner peripheral surface of the flow passage 2, and the upper surface of the device layer 11 is also continuously covered with the second functional layer 41. By causing the second functional layer 41 to be formed such that the second functional layer 41 which has spread out of one of the plurality of flow passages 2 enters another flow passage 2, the adhesion can be further improved.

In this way, one second functional layer 41 continuously protects the respective opening portions of a plurality of flow passages 2, and the adhesion area can thus be further ensured.

In addition, in this configuration as well, since the end portion 41a of the second functional layer 41 is formed between the device layer 11 and the ejection port forming substrate 50, the end portion 41a, which is located on the upper surface of the device layer 11, of the second functional layer 41 is protected by the ejection port forming substrate 50.

With this configuration as well, the adhesion between a flow passage forming substrate and a functional layer can be improved.

### Fourth Modification in First Embodiment

FIG. 6G is a schematic sectional view of a liquid ejection substrate 21 in a fourth modification.

FIG. 6H is a schematic plan view of the liquid ejection substrate 21 in the fourth modification.

As shown in FIG. 6G and FIG. 6H, the first functional layer 31 and the second functional layer 41 may be formed from an inner side of the ejection port forming substrate 50 to a middle thereof, between the device layer 11 and the ejection port forming substrate 50.

According to this configuration, since the end portion of the first functional layer 31 and the end portion of the second functional layer 41 are protected by the ejection port forming substrate 50, the permeation of the liquid into the interface between the device layer 11 and the first functional layer 31 can be suppressed.

In addition, as shown in FIG. 6H, one second functional layer 41 may continuously protect outlets of a plurality of flow passages 2 which are formed along the Y-direction.

With this configuration as well, the adhesion between a flow passage forming substrate and a functional layer can be improved.

### Fifth Modification in First Embodiment

FIG. 6I is a schematic sectional view of a liquid ejection substrate 21 in a fifth modification.

FIG. 6J is a schematic plan view of the liquid ejection substrate 21 in the fifth modification.

As shown in FIG. 6I and FIG. 6J, the first functional layer 31 and the second functional layer 41 may be formed from an inner side of the ejection port forming substrate 50 to a middle thereof, between the device layer 11 and the ejection port forming substrate 50.

According to this configuration, since the end portion of the first functional layer 31 and the end portion of the second functional layer 41 are protected by the ejection port forming substrate 50, the permeation of the liquid into the interface between the device layer 11 and the first functional layer 31 can be suppressed.

In addition, as shown in FIG. 6J, one second functional layer 41 may continuously protect outlets of a plurality of flow passages 2 which are formed along the X-direction.

In the case where the energy generation elements 1 are disposed at a high density and the interval between two ejection ports 5 in the X-direction is short, the configuration in which the second functional layer 41 continuously protects a plurality of flow passages 2 as in the present modification is particularly effective.

For example, in the case where the interval between two ejection ports 5 is 40 μm or less, it is preferable that the configuration of the present modification be applied. In the case where the interval between two ejection ports 5 is 20 μm or less, it is more preferable that the configuration of the present modification be applied. In the case where the interval between two ejection ports 5 is 10 μm or less, it is further preferable that the configuration of the present modification be applied.

With this configuration as well, the adhesion between a flow passage forming substrate and a functional layer can be improved.

### Sixth Modification in First Embodiment

FIG. 6K is a schematic sectional view of a liquid ejection substrate 21 in a sixth modification.

FIG. 6L is a schematic plan view of the liquid ejection substrate 21 in the sixth modification.

As shown in FIG. 6K and FIG. 6L, in the present modification, the second functional layer 41 covers a corner portion of the first functional layer 31 from an inner peripheral surface of the flow passage 2 to an upper surface thereof, and covers the interface between the device layer 11 and the first functional layer 31, in the vicinity of an outlet of the flow passage 2.

With this configuration as well, since the interface between the device layer 11 and the first functional layer 31 is protected by the second functional layer 41, the permeation of the liquid into the interface between the device layer 11 and the first functional layer 31 can be suppressed.

### Second Embodiment

In the first embodiment, heaters are used as the energy generation elements 1. However, in the present embodiment, piezo elements are used as the energy generation elements 1. Note that in the present embodiment, the device layer 11 includes vibration plates (not shown) which deform in accordance with the drive of the piezo elements. By the drive of the vibration plates, the liquid is ejected. In the following description, configurations which are the same as or correspond to those in the first embodiment are denoted by the same signs, and different points will be mainly described.

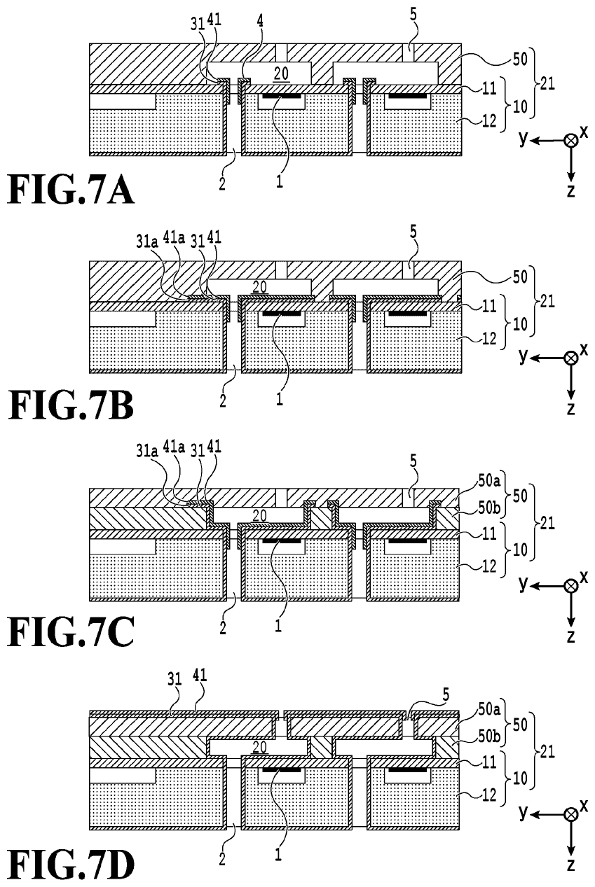

FIG. 7A is a schematic sectional view of a liquid ejection substrate 21 in the present embodiment.

As shown in FIG. 7A, the second functional layer 41 includes a configuration of covering a corner portion of the first functional layer 31 from an inner peripheral surface of the flow passage 2 to an upper surface thereof in the vicinity of an outlet of the flow passage 2.

With this configuration as well, the adhesion between a flow passage forming substrate and a functional layer can be improved.

### First Modification in Second Embodiment

FIG. 7B is a schematic sectional view of a liquid ejection substrate 21 in the present modification.

As shown in FIG. 7B, the end portion 31a of the first functional layer 31 and the end portion 41a of the second functional layer 41 are located between the device layer 11 and the ejection port forming substrate 50.

By causing the end portion 31a of the first functional layer 31 and the end portion 41a of the second functional layer 41 to be located inside the ejection port forming substrate 50 and on the outer side of the pressure chamber 20, the permeation of the liquid into the interface between the device layer 11 and the first functional layer 31 can be suppressed.

### Second Modification in Second Embodiment

FIG. 7C is a schematic sectional view of a liquid ejection substrate 21 in the present modification.

As shown in FIG. 7C, in the present modification, the ejection port forming substrate 50 includes a first layer 50a and a second layer 50b. By forming the ejection port forming substrate 50 by laminating a plurality of layers, functions necessary for the ejection port forming substrate 50 can be divided to the respective layers.

By forming the ejection port forming substrate 50 by laminating a plurality of layers in this way, the degree of freedom in design of the ejection port forming substrate 50 can be improved. Noe that the same applies to a modification of FIG. 7D.

A lower surface of the second layer 50b is fixed to an upper surface of the device layer 11. By forming the second layer 50b and the device layer 11 by using the same material, the step of forming these layers can be simplified.

For example, in the case where the upper surface of the device layer 11 is formed of silicon, the lower surface of the second layer 50b may be formed of silicon. Alternatively, in the case where the upper surface of the device layer 11 is formed of stainless steel, the lower surface of the second layer 50b may be formed of stainless steel. Note that the material for forming the upper surface of the device layer 11 and the lower surface of the second layer 50b is not limited to silicon or stainless steel.

A lower surface of the first layer 50a is fixed to an upper surface of the second layer 50b. The ejection ports 5 are formed in the first layer 50a.

In addition, the end portion 31a of the first functional layer 31 and the end portion 41b of the second functional layer 41 are located between the first layer 50a and the second layer 50b. With this configuration as well, the permeation of the liquid into the interface between the device layer 11 and the first functional layer 31 can be suppressed.

### Third Modification in Second Embodiment

FIG. 7D is a schematic sectional view of a liquid ejection substrate 21 in the present modification.

As shown in FIG. 7D, in the present modification, the first functional layer 31 continuously covers a lower surface of the silicon substrate 12, an inner peripheral surface of the flow passage 2, the pressure chamber 20, the ejection port 5, and an upper surface (an ejection port surface) of the ejection port forming substrate 50.

The second functional layer 41 covers the first functional layer 31 which is formed on the ejection port surface, from an inner side of the ejection port 5.

Incidentally, the manufacturing process for the liquid ejection substrate 21 includes a dicing step (not shown). According to the configuration of the present modification, after the dicing is performed, the end portion of the first functional layer 31 and the end portion of the second functional layer 41 are located at the end portion of the liquid ejection substrate 21 thus chipped.

Hence, with this configuration as well, the permeation of the liquid into the interface between the device layer 11 and the first functional layer 31 can be suppressed.

### Other Embodiments

Although in the above embodiments, the stop layer is used only in etching on the second functional layer 41, a stop layer may be used also in etching on the first functional layer 31. For example, films suitable as stop layers for etching on the first functional layer 31 and the second functional layer 41 may be formed on the device layer. Specifically, it is preferable that these films be formed of Ir (iridium), Pt (platinum), or the like. According to this configuration, it becomes possible to reduce a damage on the device layer at the time of etching, and facilitate the control of the etching.

In the above embodiments, the liquid ejection apparatus 100 including a line head (page wide-type head) which is long in a page-width direction (the X-direction) of a printing medium is used. However, it is also possible to apply the technology of the present disclosure to a liquid ejection apparatus including a liquid ejection head which scans in a scanning direction (the X-direction) intersecting a conveyance direction (the Y-direction) of the printing medium P in plane. That is, it is possible to apply the technology of the present disclosure also to a so-called serial-type liquid ejection apparatus.

According to the liquid ejection substrate of the present disclosure, the adhesion between a flow passage forming substrate and a functional layer can be further improved.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-211094, filed Dec. 4, 2024, which is hereby incorporated by reference herein in its entirety.

What is claimed is:

1. A liquid ejection substrate configured to eject a liquid, the liquid ejection substrate comprising:
a flow passage forming substrate having a first surface, a second surface, and a flow passage, the second surface facing in a direction opposite to a direction in which the first surface faces, the flow passage penetrating from the first surface to the second surface and being configured to allow the liquid to flow through the flow passage;
a first functional layer covering the second surface and an inner peripheral surface of the flow passage; and
a second functional layer covering the first functional layer formed on the second surface of the flow passage forming substrate.

2. The liquid ejection substrate according to claim 1, wherein the first functional layer continuously covers the second surface and the inner peripheral surface of the flow passage.

3. The liquid ejection substrate according to claim 2, wherein on an inner side of the flow passage, the second functional layer covers the entire first functional layer.

4. The liquid ejection substrate according to claim 1, wherein a stress of the first functional layer is tensile, and a stress of the second functional layer is compressive.

5. The liquid ejection substrate according to claim 1, wherein
a stress of the first functional layer is compressive,
a stress of the second functional layer is compressive, and
a stress value of the second functional layer is larger than a stress value of the first functional layer.

6. The liquid ejection substrate according to claim 1, wherein a Young's modulus of a material of the second functional layer is larger than a Young's modulus of a material of the first functional layer.

7. The liquid ejection substrate according to claim 1, wherein the second functional layer is thicker than the first functional layer.

8. The liquid ejection substrate according to claim 1, wherein
the first functional layer is a metal oxide film containing at least one of Ti, Zr, Hf, V, Nb, and Ta, and
the second functional layer is a Si compound selected from the group consisting of SiC, SiOC, SiCN, SiOCN, SiO, SiN, and SiON.

9. The liquid ejection substrate according to claim 1, wherein in a state where the second surface is viewed in a plan view, one of the second functional layer continuously covers peripheries of opening portions of a plurality of the flow passages.

10. The liquid ejection substrate according to claim 1, wherein in a state where the second surface is viewed in a plan view, one of the first functional layer continuously covers peripheries of opening portions of a plurality of the flow passages.

11. The liquid ejection substrate according to claim 1, further comprising an ejection port forming substrate including an ejection port configured to eject the liquid supplied via the flow passage, wherein
at least one end portion of the second functional layer is located at a position where the end portion does not come into contact with the liquid.

12. The liquid ejection substrate according to claim 11, further comprising an ejection port forming substrate including an ejection port configured to eject the liquid supplied via the flow passage, wherein
at least one end portion of the first functional layer is located at a position where the end portion does not come into contact with the liquid.

13. The liquid ejection substrate according to claim 11, wherein one end portion of the first functional layer and one end portion of the second functional layer are located between the flow passage forming substrate and the ejection port forming substrate.

14. The liquid ejection substrate according to claim 11, wherein
in the ejection port forming substrate, a plurality of the ejection ports are disposed along a first direction, and
in a state where the second surface is viewed in a plan view, one of the second functional layer covers peripheries of opening portions of a plurality of the flow passages formed along the first direction.

15. The liquid ejection substrate according to claim 11, wherein
in the ejection port forming substrate, a plurality of the ejection ports are disposed along a first direction, and
in a state where the second surface is viewed in a plan view, one of the second functional layer covers peripheries of opening portions of a plurality of the flow passages formed along a second direction intersecting the first direction.

16. The liquid ejection substrate according to claim 13, wherein
in the flow passage forming substrate, an energy generation element configured to generate an energy for ejecting the liquid from the ejection port is formed at a position facing the ejection port, and
in the flow passage forming substrate, the second functional layer is not formed at a position corresponding to the energy generation element.

17. The liquid ejection substrate according to claim 16, wherein the energy generation element is a heater.

18. The liquid ejection substrate according to claim 16, wherein the energy generation element is a piezo element.

19. A liquid ejection head comprising a liquid ejection substrate configured to eject a liquid, wherein
the liquid ejection substrate includes:
a flow passage forming substrate having a first surface, a second surface, and a flow passage, the second surface facing in a direction opposite to a direction in which the first surface faces, the flow passage penetrating from the first surface to the second surface and being configured to allow the liquid to flow through the flow passage;
a first functional layer covering the second surface and an inner peripheral surface of the flow passage; and
a second functional layer covering the first functional layer formed on the second surface of the flow passage forming substrate.

20. A method for manufacturing a liquid ejection substrate configured to eject a liquid, the method comprising:
a preparation step of preparing a flow passage forming substrate having a first surface, a second surface, and a flow passage, the second surface facing in a direction opposite to a direction in which the first surface faces, the flow passage penetrating from the first surface to the second surface and being configured to allow the liquid to flow through the flow passage;
a first forming step of forming a first functional layer on the second surface and an inner peripheral surface of the flow passage;
a second forming step of forming a second functional layer on the first functional layer formed on the second surface of the flow passage forming substrate;
a first etching step of etching the second functional layer; and
a second etching step of etching the first functional layer.
